(19) United States
(12) Patent Application Publication
(10) Pub. No.: US 2009/0044344 A1
(43) Pub. Date: Feb. 19, 2009

(54) Corkscrew

(75) Inventor: Ruggero Ferrari, Parma (IT)

Correspondence Address: HEDMAN & COSTIGAN P.C., 1185 AVENUE OF THE AMERICAS, NEW YORK, NY, 10036, US

(73) Assignee: Marisa Marchignoli, Parma (IT)

(21) Appl. No.: 11/920,291

(22) PCT Filed: May 24, 2005
(86) PCT No.: PCT/EP2005/005583

§ 371 Date: Nov. 13, 2007

(51) Int. Cl. B67B 7/04; B67B 7/00

(52) U.S. Cl. 7/155; 81/3.45; 81/3.29

(57) ABSTRACT

The invention is a corkscrew (1) for caps made of cork or plastics equipped with two levers (7) and (8) each having two shaped or cam outlines (11, 12) that subject corresponding teeth (41) and (51), carried by concentric barrels (4) and (5), to different movements such as to allow the complete extraction of the cap from the bottle and its ejection. The corkscrew (1) takes care of blocking the bottle neck during the worm screwing through a garter-spring tightening arrangement (6). The levers (7,8) are synchronously moved through teeth (13) that engage a toothed wheel (14).

The present invention refers to a corkscrew defined by cams that is characterised and is different from all other corkscrews due to the following performance: with only two levers and only two movements, it screws the worm into the cork, extracts it from the bottle and expels the cork from the worm, everything in an ergonomic and simple way.

Its two levers, during their cycle, control two suitably and mutually configured cams, which generate a mutual reciprocating movement along their path: this movement on one hand screws and extracts the cork, and on the other hand ejects the cork without any manual support and/or completion intervention.

Object of the present invention is providing a corkscrew that, through two levers and a suitable combination of shaped outlines, allows extracting the cork cap.

Another object is allowing, once having extracted the cap, to automatically detach this latter one from the corkscrew.

These objects and advantages are all reached by the cam corkscrew, subject of the present invention, that is characterised by what is included in the below-listed claims.

This and other characteristics will be better pointed out by the following description of some embodiments that are shown, merely as a non-limiting example, in the enclosed tables of drawing in which:

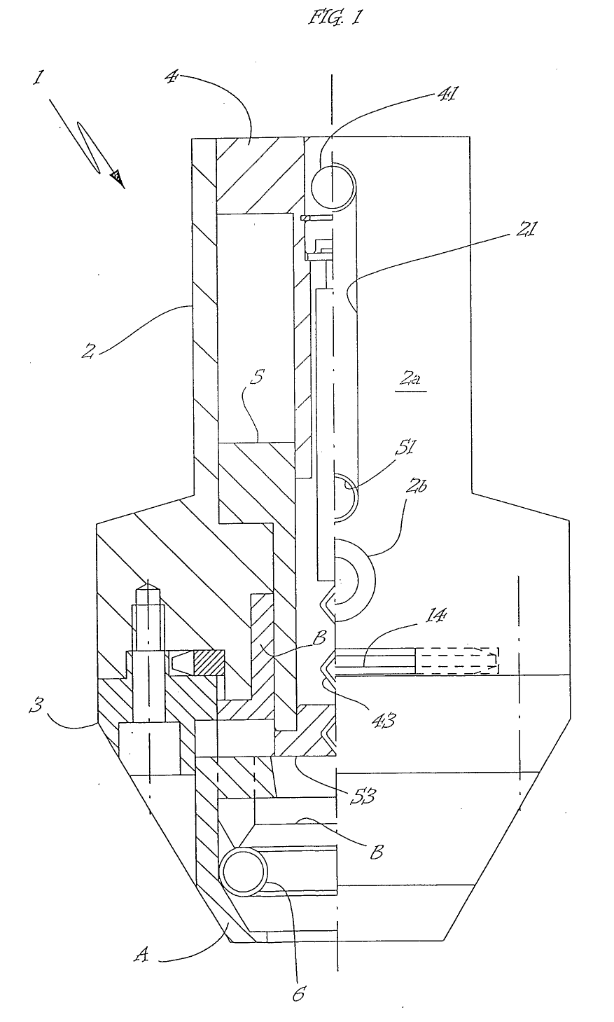

FIG. 1 shows an example of a corkscrew of the present invention;

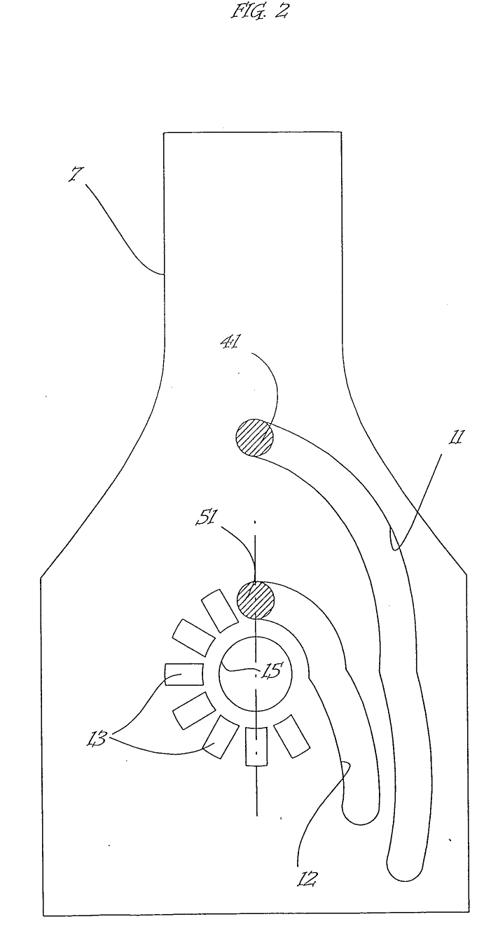

FIG. 2 shows one of the two corkscrew levers used for controlling the cap extraction steps;

FIG. 3 shows a schematic view of the position reached by corkscrew members in their starting arrangement;

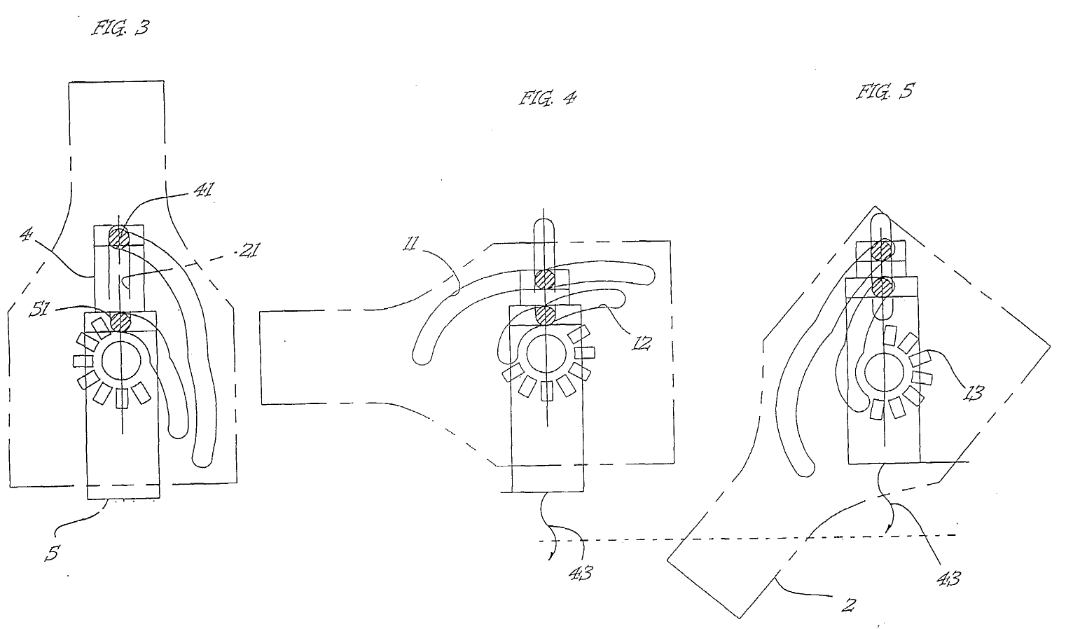

FIG. 4 shows a schematic view of the position reached by corkscrew members in their arrangement where the worm penetrates into the cap;

FIG. 5 shows a schematic view of the position reached by corkscrew members in their cap extraction arrangement.

With reference to FIG. 1, 1 designates a cam corkscrew that is essentially composed of a central body 2 and a base 3.

The central body 2 has two plane and parallel surfaces 2a and a pin 2b to allow its coupling with levers 7 and 8, which are shown in FIG. 2, through which it is possible to extract the cap as explained below.

The central body 2 contains therein several members such as two concentric barrels 4 and 5, namely the barrel 4 which is free of sliding both into the central body 2 and into the barrel 5.

Each barrel 4 and 5 is equipped with a pair of teeth 41 and 51 respectively active in corresponding openings 21 obtained on the central body 2 (and precisely along the abutment surfaces of levers 7 and 8) in order to make the barrels 4 and 5 perform a rectilinear stroke parallel to the axis of the cap to be extracted.

It can be observed that every opening 21 drives both tooth 41 and tooth 51.

Barrel 4 is equipped, in its lower end, with an idle worm 43 (in the art, it designates the helical bit that will have to be inserted into the cork) while barrel 5 is equipped in its lower part with a helical (fixed) bush 53 which said worm 43 engages, thereby allowing their rotation-translation.

In the lower part of the central body and base 3, a garter spring arrangement 6 is located for anchoring the corkscrew to the bottle and which is composed of two parts, designated in this example by A and B; part B is fixed to the central body 2 and is inserted in the corresponding part A that instead is free of vertically sliding with respect to this latter one.

It follows that, once having inserted the bottle to be opened into the corkscrew 1 initially when the screwing action is performed, part A remain recalled upwards and the spring compressed around the bottle neck blocking it.

With reference to FIG. 2, one of the two levers 7 and 8 can be observed and precisely its internal part that gets in contact with the corresponding surface 2a of the body 2; two shaped or cam grooves are obtained on the lever, called herein below shaped outlines and designated by references 11 and 12, each one of which is respectively put in contact with tooth 41 and tooth 51, however not before that such teeth have been inserted in their corresponding openings 21 as described before.

Outline 11 is different from outline 12 that is used for extracting the cap in order to allow, as described below, screwing and unscrewing the cap easily and without problems.

Always from FIG. 2, it can be observed that every lever has a series of teeth 13 that will mesh with a corresponding toothed wheel 14 placed inside the corkscrew 1, between the central body 2 and the base 3 once the lever is centred through its hole 15 around pin 2b.

With reference to FIGS. 3, 4 and 5, the functional diagram of the lever corkscrew 1 with its main internal components is shown.

By placing the corkscrew 1 with lifted levers onto the bottle to be uncorked (FIG. 3) and by rotating levers 7 and 8, first of all the anchoring of the bottle with the garter spring 6 occurs (by lifting part A with respect to part B) and afterwards, by going on rotating, the idle worm 43 screwing into the cork is obtained (FIG. 4) and afterwards its extraction by means of the complete stroke of teeth 41 and 51.

Now, the two levers are completely lowered and both barrels are completely lifted (FIG. 5).

By returning the two levers 7 and 8 towards their initial position (namely by performing a counter-rotation), both barrels 4 and 5 simultaneously descend down to their bottom centre (the same shown in FIG. 4) and afterwards, by going on with their counter-rotation, only barrel 4 is lifted up while barrel 5 remains, due to the effect of the arrangement of outline 12, in its bottom centre: it follows that the idle worm starts being unscrewed from the cap due to the rotation performed by the bush 53 secured to the barrel 5 (within which the worm is passed).

It is clear that, before performing the above counter-rotation, it is necessary to remove the uncorked bottle, however already released also by the garter spring 6.

Corkscrew 1 is now again in its initial position ready for its following uses.

During the above-described steps, movements of levers are ensured in perfect synchronism through the assembly both of toothed wheel 14 and of the teeth 13 obtained in the levers and described previously.

For a better clarification, the sequence to be performed for extracting and ejecting a cork from a bottle is summarised by steps:
Placing the bottle neck inside the lower opening obtained in part A of the helical-spring closure arrangement, and precisely this bottle is placed against the bush 53; the levers 7 and 8 are vertically placed;
Tightening the bottle neck by this garter spring 6 during the descent of worm 43 caused by the rotation pressure to which levers 7 and 8 are subjected;
Descending the barrel 4 and completely screwing the idle worm 43 into the cork; the barrel 4 reaches the lower centre given by the corresponding outline 11 (FIG. 4);
Extracting the cork due to the continuation of the rotation previously performed onto the levers 7 and 8 and due to the simultaneous rise of the barrels 4 and 5 imposed by the corresponding outlines 11 and 12; the barrels 4 and 5 keep the same distance so that the worm 43 does not rotate in the bush 53 and therefore the cap follows the worm 43 stroke without being unscrewed; the levers are completely lowered and the barrels are in their maximum position inside the central body 2 of the corkscrew 1 (FIG. 5);
Moving away the uncorked bottle (the helical spring 6 is not kept any more against the bottle neck by parts A and B);
Counter-rotating the levers 7 and 8 in order to bring back the corkscrew 1 to its initial configuration; both barrels firstly go back to their lower centre (FIG. 4) and following a further counter-rotation, the barrel 4 rises again till it gets to its initial configuration while barrel 5, remaining in position, makes the idle worm 43 unscrewed from the cork.

1. Corkscrew (1) for caps made of cork, of a type comprising a central body (2) and a base (3) joined thereto; the central body (2) having two plane and parallel surfaces (2a) each one of which has a pin (2b) that allows a coupling with levers (7, 8), characterised in that said levers (7, 8) have shaped or cam outlines (11, 12), each one of which is respectively put in contact with teeth (41, 51) projecting from a pair of concentric barrels (4) and (5) inserted in the central body (2); the shaped outlines (11, 12) allow extracting and ejecting the cork.

2. Corkscrew (1) according to claim 1, characterised in that the barrel (4) has a worm (43) while the barrel (5) has a bush (53) inside which said worm (43) is engaged.

3. Corkscrew (1) according to claim 1, characterised in that each tooth (41 and 51) is coupled with the corresponding group of outlines (11 and 12) by passing into a rectilinear opening (21) obtained on the central body (2) so that the barrels (4) and (5) perform a rectilinear stroke along the axis of the cap to be extracted; the opening (21) drives both the tooth (41) and the tooth (51).

4. Corkscrew (1) according to claim 1, characterised in that the levers (7, 8) are symmetrically connected to the central body (2) and are free of rotating along the axis of the pin (2b) projecting from the surface (2a).

5. Corkscrew (1) according to claim 1, characterised in that every lever (7, 8) has a series of teeth (13) that mesh with a corresponding perpendicular toothed wheel (14) placed inside the corkscrew (1), between the central body (2) and the base (3) in order to mutually affect the movement of the two levers.

6. Corkscrew (1) according to claim 1, characterised in that in the lower part of the central body (2) and of the base (3) a garter spring arrangement (6) is placed for anchoring the corkscrew to the bottle, such arrangement (6) being composed of two parts (A and B); part (B) is fixed to the central body (2) and is inserted into the corresponding part (A) that instead is free of vertically sliding with respect to this latter one; once having inserted the bottle to be opened into the corkscrew (1) when initially the screwing action is performed, part (A) is returned upwards and the garter spring (6) compressed around the bottle neck blocking it.

7. Process for extracting a cork from a bottle characterised in that such process extract the cork from a bottle and ejects it from the corkscrew through the following steps:
Placing the corkscrew onto the bottle neck inside the lower opening obtained in part (A) of the helical-spring closure arrangement, and precisely said bottle is placed against the bush (53); the levers (7 and 8) are vertically placed;
Tightening the bottle neck by said garter spring (6) during the descent of the worm (43) caused by the rotation to which levers (7 and 8) are subjected;
Descending the barrel (4) and completely screwing the worm (43) into the cork; the barrel (4) reaches the lower centre given by the corresponding outline (11) (FIG. 4);
Extracting the cork from the bottle neck due to the continuation of the rotation previously performed onto the levers (7 and 8) and due to the simultaneous rise of the barrels (4 and 5) imposed by the corresponding outlines (11 and 12); the barrels (4 and 5) keep the same distance so that the worm (43) does not rotate in the bush (53) and therefore the cap follows the stroke of worm (43) and bush; the levers are completely lowered and the barrels are in their maximum position inside the central body (2) of the corkscrew (1) (FIG. 5);
Moving away the uncorked bottle (the helical spring (6) is not kept any more against the bottle neck by parts (A and B));
Counter-rotating the levers (7 and 8) in order to bring back the corkscrew (1) to its initial configuration; both barrels firstly go back to their lower centre (FIG. 4) and following a further counter-rotation, the barrel (4) rises again till it gets to its initial configuration while the barrel (5), remaining in position, makes the worm (43) unscrew the cork.
